(19) United States
(12) Patent Application Publication
(10) Pub. No.: US 2019/0155392 A1
(43) Pub. Date: May 23, 2019

(54) USER INTERFACE SYSTEM BASED ON POINTING DEVICE

(71) Applicant: Koninklijke Philips N.V., Eindhoven (NL)

(72) Inventors: Hendricus Theodorus Gerardus Maria PENNING DE VRIES, Mierlo (NL); Robert Heinz KOLL, Eindhoven (NL); Johannes Yzebrand TICHELAAR, Eindhoven (NL)

(21) Appl. No.: 15/507,786

(22) PCT Filed: Sep. 30, 2015
(86) PCT No.: PCT/EP2015/072530

§ 371 Date: Mar. 1, 2017

(30) Foreign Application Priority Data
Sep. 30, 2014 (EP) 14187126.9

(51) Int. Cl. G06F 3/01; G06K 9/00; G06T 7/70

(52) U.S. Cl. CPC G06F 3/017; G06T 7/70; G06K 9/00335

(57) ABSTRACT

A user interaction system (1) is provided that comprises an electrical apparatus (10), a beacon (16) that radiates a photon radiation (R16), a portable pointing device (12) operable by a user for pointing to a region in space (20), which portable pointing device includes a camera (122) connected thereto for obtaining images from said space and a digital signal processor (14). The digital signal processor (14) is capable of receiving and processing the images, and of transmitting user interface information, derived by processing the images, to the electrical apparatus. The digital signal processor (14) determines successive positions of a representation of the at least one beacon in images obtained by the camera, estimates the motion trajectory from the successive positions outputs a motion characterizing signature representing the motion trajectory; identifies the motion characterizing signature and outputs corresponding command identification from which command identification data the user interface information is constructed.

### FIELD OF THE INVENTION

The present invention pertains to user interaction system.

The present invention further pertains to user interaction method.

The present invention further pertains to a portable pointing device.

The present invention still further relates to a storage medium.

### BACKGROUND OF THE INVENTION

WO2004047011 discloses a portable pointing device connected to a camera and sending pictures to a digital signal processor, capable of recognizing an object and a command given by the user by making a gesture with the portable pointing device, and controlling an electrical apparatus on the basis of this recognition. The cited document further suggests that motion can be determined by imaging successive pictures and applying a motion estimation algorithm.

For example a gesture in the form of an upward motion may be used to increase an audio volume of a controlled apparatus. A circular motion trajectory might be used to “rewind”, i.e. to cause a playback apparatus to return to an earlier point in time in the content that is reproduced.

### SUMMARY

It is an object to provide a user interaction system which is improved in that it enables a more efficient way of recognizing gestures made with the portable pointing device.

It is a further object to provide a user interaction method which is improved in that it enables a more efficient way of recognizing gestures made with the portable pointing device.

It is a still further object to provide a portable pointing device allowing for a more efficient way of recognizing gestures made therewith. It is a still further object to provide a storage medium having stored thereon a computer program enabling a more efficient way of recognizing gestures with a digital signal processor.

In accordance with the object first mentioned a user interaction system according to a first aspect of the invention is provided that comprises an electrical apparatus, a portable pointing device, and a digital signal processor. The portable pointing device is operable by a user for pointing to a region in space and includes a camera connected thereto for obtaining subsequent images from said space. The digital signal processor is capable of receiving and processing the subsequent images to determine a motion of said pointing device, and capable of transmitting user interface information to the electrical apparatus if it is determined that the motion as determined corresponds to a predetermined gesture. The user interface information represents control information for control of the electrical apparatus in accordance with the predetermined gesture. The electrical apparatus, e. g. a computer or a television, then performs an action corresponding to the user interaction command.

The user interaction system is characterized in that the digital signal processor comprises a pattern recognition module for recognizing a predetermined pattern in said subsequent images, a position estimation unit for estimating a position of said pattern in said subsequent images, and a gesture matching unit for matching a predetermined gesture on the basis of data indicative for differences of said position (position differences) in said subsequent images.

In the user interaction system according to the present invention the gesture matching unit compares the data indicative for differences of said position differences with respective position differences corresponding to respective predetermined gestures.

Typically the user indicates the beginning and end of a gesture made with the pointing device, for example by pressing and releasing an activation button.

It is however not necessary to postpone the comparison until a complete sequence of position differences is retrieved from the subsequent captured images. Instead immediately after capturing the second and each subsequent image, i.e. while the gesture is being performed, the gesture recognition process compares the determined position difference with the corresponding position differences known for the various predetermined gestures Therewith a fast response is possible. I.e. at the moment that the user indicates that s/he completed the gesture, the preceding position differences have already been processed to determine the most likely gesture that could have caused the determined position differences of the predetermined pattern between successive captured images, and a user interface information with the proper control command can be transmitted to the apparatus. It would even be possible to transmit a control command even before the user indication once the position differences received so far can only be attributed to a single gesture, i.e. the likelihood of the most likely gesture has reached a predetermined threshold. It has been found however that operation is more reliable if gesture recognition is continued until the user provides the indication that user that s/he completed the gesture or the end of the gesture is detected automatically.

Furthermore, the digital signal processor is capable of determining successive positions of a predetermined pattern in images obtained by the camera, and of estimating the position differences from these successive positions. This simplifies the estimation of the motions of the portable pointing device, in that it is no longer necessary to detect these motions by comparing the images in its entirety, but that it suffices to compare the positions predetermined pattern in the images taken by the camera. This is relatively easy due to the fact that a predetermined spot or shape or combinations thereof can be identified within the image. This is advantageous for a portable pointing device as less processing power is required and therewith longer battery lifetime is obtained.

In an embodiment of the user interaction system according to the first aspect the digital signal processor further includes a spatial transformation unit for applying a spatial transformation to the estimated position in order to obtain an estimated pointing position. This facilitates a more intuitive control by the user as the user can sometimes more easily imagine a gesture to be formed in terms of a trajectory followed by a pointing position than a trajectory followed by the position where the predetermined pattern will be detected in the camera image.

In order to further facilitate user control, a user interaction system is provided wherein the controlled electrical apparatus includes a display screen, and the controlled electrical apparatus is arranged to display the estimated pointing position on the display screen.

The predetermined pattern may result from any absolute reference in space that can be detected. For example if the apparatus to be controlled is a television or other device having a display screen for displaying active video content, the predetermined pattern to be detected is the portion in the camera image that comprises active video in contrast to a stationary environment

Alternatively, or in addition one or more beacons may be arranged in the space that radiate photon radiation. In that case the predetermined pattern to be recognized is a pattern resulting from the one or more beacons. This has the advantage that the operation of the system according of the first aspect becomes independent of the video content made available by the apparatus to be controlled.

Each of the one or more beacons may be associated with a respective controllable apparatus. In that case feedback may be provided to the user indicating which beacon is pointed at, as this implies which of the various apparatuses is currently under control. Such feedback may be provided for example visually by a lighting element arranged near the beacon pointed at, or by a display on the pointing device showing an overview of the various apparatuses and/or their beacons.

A beacon may be any photon-radiating means that provides for a detectable pattern (a dot, cluster or other arrangement of dots, a geometrical shape) in the camera image. Preferably the photon radiation emitted by the beacon is not visible to human beings, for example photon radiation having a wavelength in the infra red range.

In accordance with the object second mentioned above, a user interaction method is provided in a system comprising an electrical apparatus, a portable pointing device with a camera, and a digital signal processor. The method comprises

making a gesture with said portable pointing device,

capturing successive images with said camera comprised in the portable pointing device while making the gesture; and

receiving successive image data representing said successive images by said digital signal processor,

processing the successive image data by said digital processor,

transmitting user interface information to the electrical apparatus, which user interface information is constructed from said command identification data. The processing referred to above, includes

determining successive positions of a predetermined pattern in said successive images obtained by the camera,

identifying a gesture on the basis of difference data resulting from differences of said position in said successive images,

outputting command identification data representing a user interaction command corresponding with the identified gesture. The user interface information transmitted to the electrical apparatus is constructed from said command identification data.

In accordance with the object third mentioned above a portable pointing device is provided that is operable by a user for pointing to a region in space. The portable pointing device includes a camera connected thereto for obtaining images from said space and a digital signal processor. The digital signal processor is capable of receiving and processing the images, and capable of receiving and processing the subsequent images to identify a gesture made with said pointing device, and capable of transmitting user interface information to the electrical apparatus, said user interface information representing control information for said electrical apparatus corresponding to the identified gesture. The digital signal processor comprises a pattern recognition module for recognizing a predetermined pattern in said subsequent images and for estimating a position of said pattern in said subsequent images, and a gesture matching unit for identifying a gesture on the basis of difference data resulting from differences of said position in said subsequent images.

In an embodiment the digital signal processor further includes a spatial transformation unit for applying a spatial transformation to said estimated position in order to obtain an estimated position (pointing position) of a location pointed to by the user with the portable pointing device.

In an embodiment the electrical apparatus includes a display screen, and is arranged to display said estimated pointing position on said display screen.

In an embodiment the predetermined pattern to be recognized is a pattern resulting from photon radiation emitted by at least one beacon.

The camera of the portable pointing device is capable of detecting radiation from at least one beacon arranged in said space and the digital signal processor is capable of determining successive positions of a representation of the at least one beacon in images obtained by the camera, and of estimating the motion trajectory from said successive positions.

The detection of the at least one beacon may be facilitated by one or more of the measures in the embodiments presented below.

In an embodiment the at least one beacon radiates non-visible radiation and the camera is substantially insensitive to radiation other than the non-visible radiation radiated by the at least one beacon. This may be achieved in that the camera has sensor elements that are intrinsically insensitive to said radiation other than the non-visible radiation, or in other ways, for example by an optical filter arranged in front of the camera that selectively passes the non-visible radiation of the at least one beacon. For example the at least one beacon may be an IR beacon and the camera may be an IR camera.

If multiple beacons are used it may be desired to provide further features that facilitate identification of the contribution of the various beacons to predetermined patterns in the captured image. Regardless whether or not multiple beacons are used, this may also be relevant if photon radiation sources are present in the environment that could disturb a proper recognition of the predetermined patterns.

In an embodiment the at least one beacon comprises a driving unit to drive a photon radiation element of said beacon according to a time-modulated pattern and the digital signal processor includes a detector for detecting image data modulated according to that pattern. The intensity may for example be modulated according to a sine pattern having a modulation frequency, and the detector may be arranged to detect image data varying with this frequency and to ignore other image data. Any modulation pattern, for example a sine wave pattern may be used for modulation.

In an embodiment the at least one beacon comprises a photon radiation element capable of radiating photon radiation at mutually different wavelengths, and a driving unit to drive modulate wavelength of the photon radiation element according to a time-modulated pattern and the digital signal processor includes a detector for detecting image data modulated according to that pattern.

In an embodiment the at least one beacon is arranged to emit photon radiation according to a unique spatial pattern and/or a set of beacons is arranged to emit photon radiation according to a unique spatial pattern, and the digital signal processor is provided with a pattern recognition module that identifies the unique spatial pattern as the predetermined pattern within image data retrieved from the camera.

### BRIEF DESCRIPTION OF THE DRAWINGS

These and other aspects are described in more detail with reference to the drawings. Therein:

FIG. 1 shows an embodiment of a user interaction system according to the first aspect of the invention,

FIG. 2 shows an embodiment of a portable pointing device according to the third aspect of the invention in more detail, and schematically shows its relationship to other parts of the user interaction system,

FIG. 3 in more detail shows a digital signal processor as used in an embodiment of a user interaction system according to the first aspect of the invention,

FIG. 3A shows a part of the digital signal processor of FIG. 3 in more detail,

FIG. 4A, 4B schematically shows two views of a portable pointing device according to the third aspect of the invention as well as a definition of its position and orientation in space,

FIG. 5A, 5B in part show two embodiments of a user interaction system according to the first aspect of the invention,

FIG. 6A, 6B shows two embodiments of a portable pointing device according to the third aspect of the invention in more detail,

FIG. 7A shows an embodiment of a portable pointing device according to the third aspect of the invention in more detail,

FIG. 7B shows an example of a set of beacons arranged in space, for use with the portable pointing device of FIG. 7A.

FIG. 8 in more detail shows an embodiment of a portable pointing device according to the third aspect of the invention as well as a beacon for use therewith,

FIG. 9 in more detail shows an embodiment of a portable pointing device according to the third aspect of the invention as well as a beacon for use therewith,

FIG. 9A shows a part of the portable pointing device of FIG. 9 in more detail,

FIG. 10 schematically shows an embodiment of a method according to the second aspect of the invention

FIG. 11 schematically shows a further embodiment of a system according to the first embodiment of the invention.

### DETAILED DESCRIPTION OF EMBODIMENTS

Like reference symbols in the various drawings indicate like elements unless otherwise indicated.

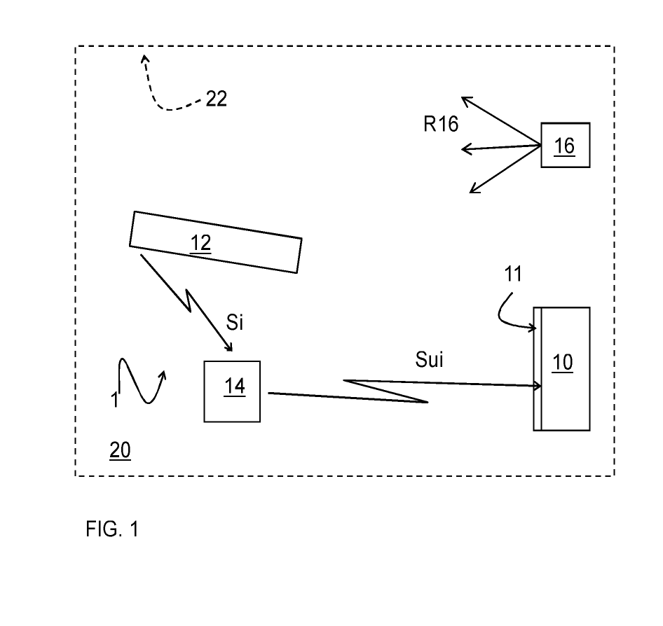

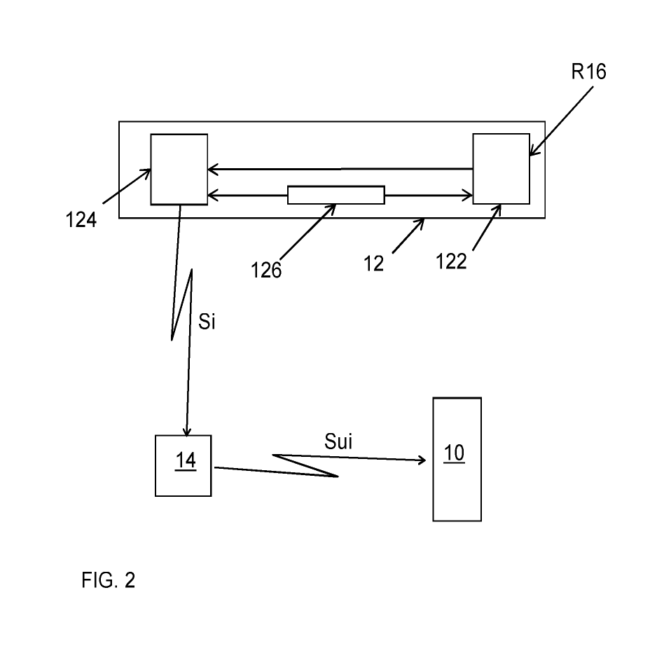

FIG. 1 schematically shows a user interaction system 1 that comprises an electrical apparatus 10, a portable pointing device 12 operable by a user for pointing to a region in space 20, a digital signal processor 14, and further at least one beacon 16 that radiates a photon radiation R16. The space 20 may be bounded by a boundary 22, e.g. formed by walls. The at least one beacon is arranged in the space 20 and is not part of the portable pointing device 12. The digital signal processor 14 may be a separate device (as shown in FIG. 1 and 2 for example) or may be integrated in another device, such as the portable pointing device 12 or the electrical apparatus 10.

The portable pointing device 12, of which an embodiment is shown in more detail in FIG. 2, includes a camera 122 connected thereto for obtaining images from the space 20. The portable pointing device 12 as shown in FIG. 2 further includes a wireless transmission unit 124 and a power supply unit 126, e.g. a replaceable or rechargeable battery and/or a power generation facility, e.g. including solar cells or a unit for conversion of mechanic into electric energy.

The digital signal processor 14 is capable of receiving and processing the images, and is capable of transmitting user interface information to the electrical apparatus, which is derived by processing the images. In the embodiments of FIG. 1,2 the wireless transmission unit 124 of portable pointing device 12 wirelessly transmits data Si representing the obtained images and digital signal processor 14 on its turn wirelessly transmits data Sui representing the user interface information to the electrical apparatus 10.

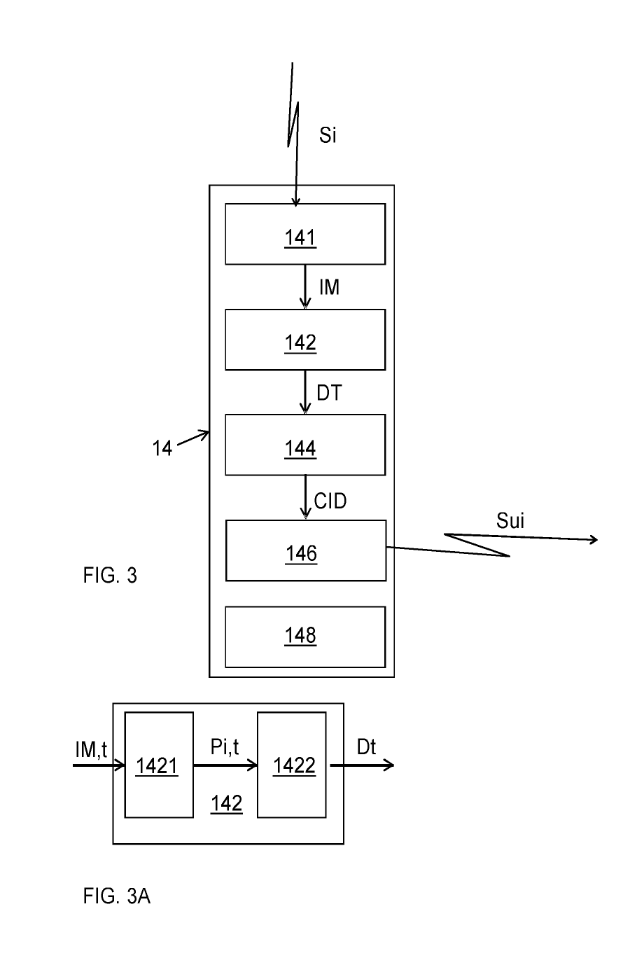

As shown in more detail in FIG. 3, the digital signal processor 14 comprises a motion trajectory estimation unit 142 for estimating a motion trajectory of the portable pointing device 12. During operation the motion trajectory estimation unit 142 outputs a first motion characterizing signature MS. The signature is a mathematical abstraction of the motion trajectory. Signature identification unit 144 is provided for identifying the first motion characterizing signature MS and therewith serves as a gesture matching unit. During operation the signature identification unit 144 output command identification data CID, which represents a user interaction command. The user interaction command represented by the command identification data CID corresponds with the first motion characterizing signature MS. The user interface information Sui is constructed from the command identification data CID. In the example shown in FIG. 3, the wireless receiving unit 141 of digital signal processor 14 receives the data Si from the portable pointing device 12. Wireless transmission unit 146 wirelessly transmits the user interface information Sui to the electrical apparatus 10 that is controlled by the user interface information Sui. Alternatively the digital signal processor 14 may be integrated in the portable pointing device 12. In this case wireless transmission unit 124 and wireless receiving unit 141 are superfluous. Alternatively, although less practical, the digital signal processor 14 and the portable pointing device 12 could be coupled by a cable to obviate a wireless transmission by units 124 and 141. As another alternative the digital signal processor 14 may be integrated in the electrical apparatus 10 to be controlled. In this case wireless transmission unit 146 and a wireless receiving unit for the electrical apparatus are superfluous. Similarly, in this case a wired coupling between the digital signal processor 14 and the electrical apparatus 10 could be contemplated to obviate a wireless transmission between the digital signal processor 14 and the electrical apparatus 10.

In again another embodiment two or more of the portable pointing device 12, the digital signal processor 14 and the electrical apparatus 10 to be controlled may be coupled via a common wireless or wired network.

The digital signal processor 14 is capable of determining successive positions of a representation of the at least one beacon 16 in images obtained by the camera 122. The digital signal processor 14 can estimate the motion trajectory from these successive positions.

The digital signal processor or parts thereof may be implemented as an ASIC, which might be hardcoded. Alternatively the digital signal processor or parts thereof may be implemented as a generally programmable processor carrying out a program stored in storage medium. Also intermediate implementations are possible, in the form of processors having an instruction set for a restricted set of operations, reconfigurable processors and combinations thereof. In the embodiment shown in FIG. 3, (parts of) the digital signal processor are implemented as a generally programmable processor. A storage medium 148 is provided, having stored thereon a computer program enabling the digital signal processor 14 to carry out various functions.

FIG. 3A shows in more detail an example of motion trajectory estimation unit 142. The motion trajectory estimation unit 142 has a patter recognition module 1421 that receives data of images IM,t, for successive points in time t. The pattern recognition module 1421 identifies the position Pi,t of the predetermined pattern, for example a predetermined pattern that would result from at least one beacon 16 in these images IM,t and provides information representing the position Pi,t to the relative position determining module 1422. The latter determines the relative position of a position Pi,t at point in time t with respect to the corresponding position Pi,t-1 in the image Pi,t-1 of the preceding point in time t-1. In response the relative position determining module 1422 provides difference data Dt resulting from differences of said position Pi,t at is output. In an embodiment the difference data is obtained by subtracting the coordinates of subsequent position, i.e.

therein Dt=Pi,t−Pi,t−1

In other embodiments the difference data Dt resulting from differences of said position Pi,t is obtained by applying a spatial transformation to said estimated position in order to obtain an estimated pointing position. Subsequently, the difference data Dt is determined from the difference in coordinates between subsequent pointing positions.

One relative position Dt or a sequence Dt, Dt+1, . . . ,Dt+n of these relative positions forms a motion characterizing signature MS.

One relative position indicative for an upward movement may for example represent a gesture to be used for turning on the electrical apparatus 10. Another relative position indicative for an opposite movement may for example represent a gesture to be used for turning off the electrical apparatus.

A motion characterizing signature MS composed of a sequence of relative positions may be used to extend the range of possible gestures. More complex gestures may be used for restricted control purposes. For example, a particular gesture only known by the user or by a restricted group of users may be used as a password to obtain exclusive access to the electrical apparatus 10.

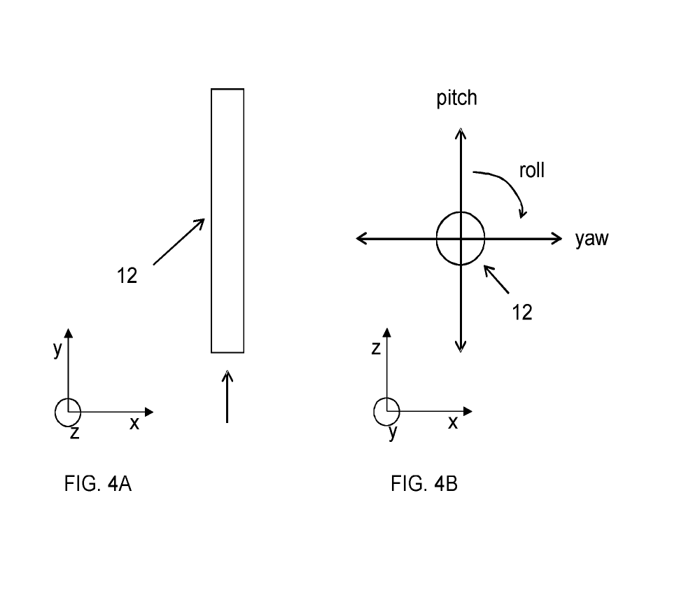

A reliable relative position Dt may already be obtained with a single beacon 16, provided that the user takes care that s/he operates the portable pointing device 12 from a fixed position with respect to the single beacon 16 and holds the portable pointing device 12 in a fixed roll angle, as defined in FIG. 4A, 4B. It is further noted that in some embodiments it may not be necessary to exactly determine the value of relative position. For example if it may be sufficient to detect a non-zero value for the relative position in order to toggle a function of the electrical apparatus 10. For example a non-zero value of Dt may be interpreted as a command for switching on the electrical apparatus 10 if the electrical apparatus is currently switched off. Analogously, a non-zero value of Dt may be interpreted as a command for switching on the electrical apparatus 10 if the electrical apparatus is currently switched off.

As indicated above, a single beacon suffices if the roll angle is fixed, or if effects of variations of the roll angle can be compensated using data indicative for an observed roll angle as detected by a roll angle detector. In the absence of a roll angle detector compensation for variations in the roll angle would still be possible if more than one beacon is used.

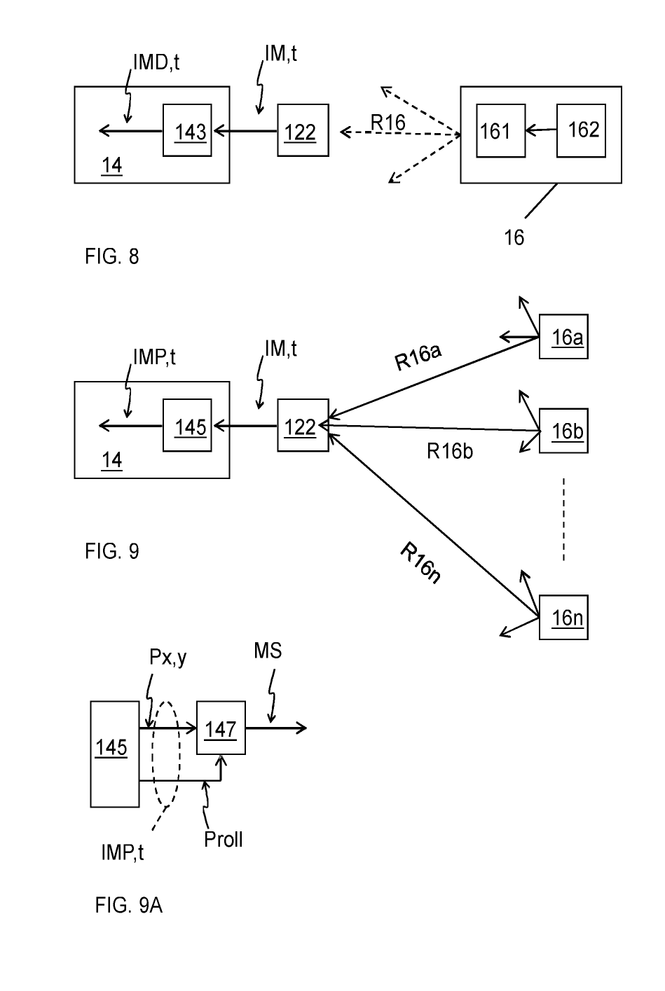

In an embodiment, the at least one beacon 16a, is part of a set of beacons 16a, 16b, etc. A pair of beacons 16a, 16b already is sufficient to determine a roll angle and to use the observed value of the roll angle for roll angle compensation. In this case each image IM,t results in a pair of positions Pi,t, one for each of the beacons. Nevertheless, more beacons may be used if desired. In this case each image IM,t results in three positions Pi,t, one for each of the beacons. As an alternative or additional measure, the beacons may have a characteristic ‘signature’, enabling the pattern recognition module 1421 to determine which image data results from each of the beacons. In that case it would already be sufficient to have two beacons, of which one is identifiable by its characteristic ‘signature’. The signature of the identifiable beacon may for example be provided in that a driving unit 162 drives a photon radiation element 161 of the beacon according to a time-modulated pattern. FIG. 8 shows an example, wherein further the digital signal processor 14 includes a detector 143 for detecting image data (IMD,t) modulated according to the time-modulated pattern.

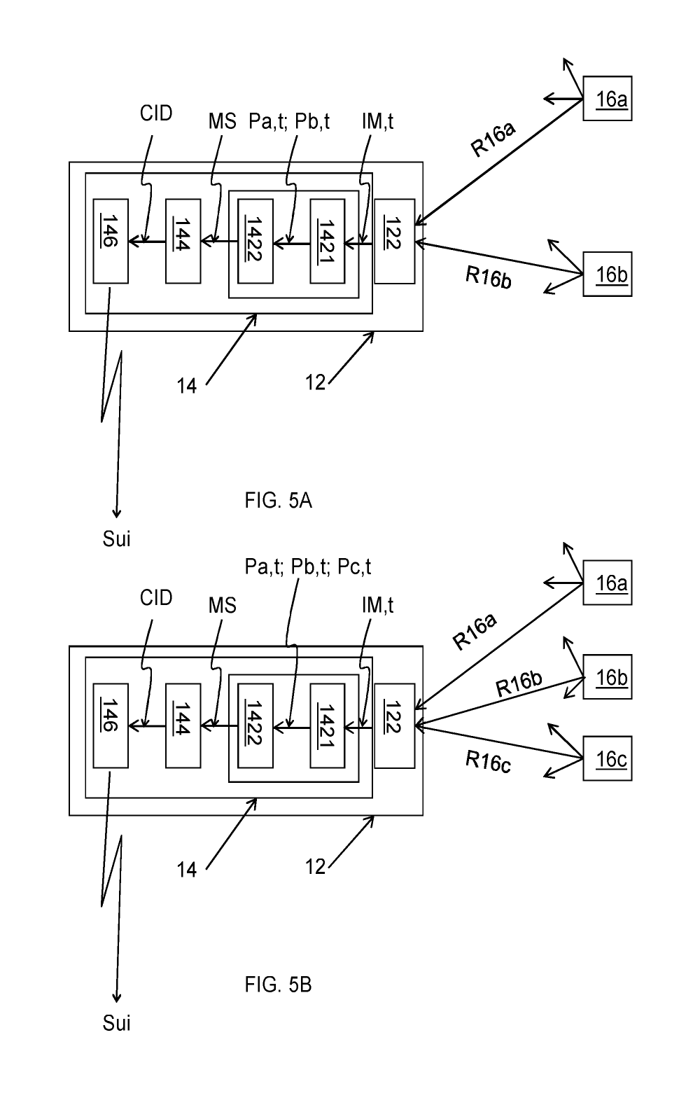

FIG. 5A shows an example of an embodiment wherein a set of two beacons 16a, 16b is used. FIG. 5B shows an alternative example wherein a set of three beacons 16a, 16b, 16c is used. In the examples shown here the digital signal processor 14 is integrated in the portable pointing device 12. In order not to obscure the drawing a power source is not shown.

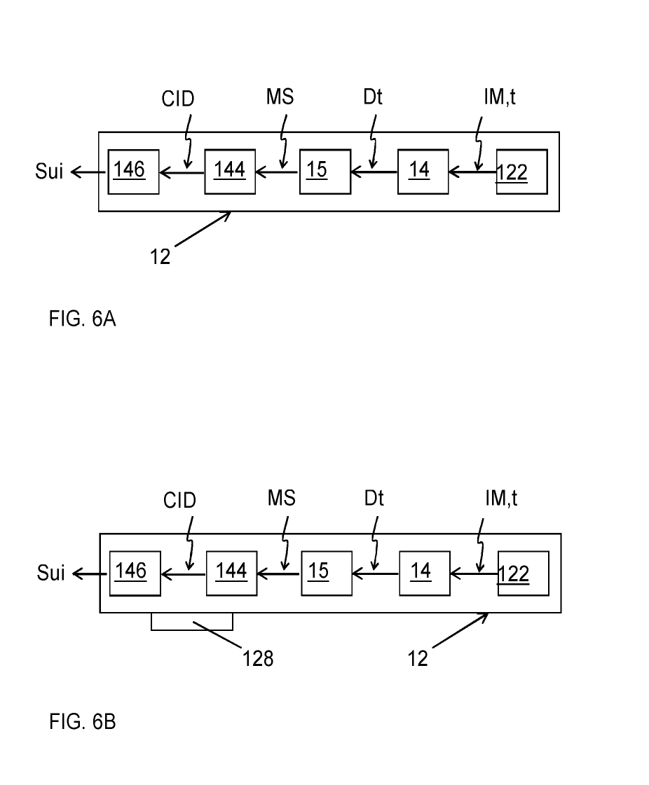

FIG. 6A shows again another embodiment, wherein the portable pointing device 12 is provided with a spatial transformation unit 15, here including a roll-detection and correction module. Image data IM,t is processed by digital signal processor to obtain relative orientation data Dt. The roll-detection and correction module detects a roll-angle wherein the portable pointing device 12 is hold. The detected value for the roll angle is used to apply a compensation to the relative orientation data Dt to obtain a motion characterizing signature MS that is independent of the roll-angle of the pointing device. It is noted that alternatively a roll-detection and correction module may be applied to correct image data IM,t. The motion characterizing signature MS is subsequently identified by signature identification unit 144. Wireless transmission unit 146 wirelessly transmits the user interface information Sui to the electrical apparatus 10 that is controlled by the user interface information Sui. Roll detection and correction module 15 may include for example one or more of an accelerometer, a magnetometer, and a gyroscope to determine the roll angle.

FIG. 6B in addition includes an activation button 128. By a depression of the activation button 128 the user may identify a beginning point of a motion trajectory representing a gesture, and by releasing the activation button 128 the user may identify the end point of that motion trajectory. In his way the task for the signature identification unit 144 to recognize signatures MS and to determine the proper command CID is simplified. Also ambiguities can more easily be avoided. For example a motion trajectory A may be used to represent a first gesture associated with a first command, a motion trajectory B may be used to represent a second gesture associated with a second command, and a motion trajectory AB, comprising a concatenation of motion trajectories A and B may be used to represent a third gesture associated with a third command. In addition a motion trajectory BA, comprising a concatenation of motion trajectories A and B in the reverse order may be used to represent a fourth gesture associated with a fourth command. Alternatively, a beginning and end of a trajectory may be signaled by another means. For example, an acceleration sensor may be provided that detects accelerations of the portable pointing device exceeding a predetermined threshold. Such excessive accelerations may then be applied by the user to indicate a beginning and end of a motion trajectory. As another example the device may include an acoustic sensor that upon detection of certain sounds signals the start or end of a trajectory. It is noted that an activation button 128 (e.g. a user knob) or an alternative means to indicate a beginning or end of a trajectory may also be applied in an other embodiment of the portable pointing device 12, for example as disclosed with reference to FIG. 2, 5A or 5B. It is further noted that an activation button 128 or an alternative means to indicate a beginning or end of a trajectory may also be applied as a means to activate the portable pointing device at the beginning of the motion trajectory and to deactivate the portable pointing device 12 after the end of the motion trajectory once the corresponding user interface command Sui has been transmitted to the electrical apparatus 10. In this way the energy consumption of the portable pointing device can be kept modest.

For a proper functioning of the portable pointing device 12 it is sufficient that the digital signal processor 14 can adequately identify the at least one beacon 16 in images IM,t obtained by the camera 122.

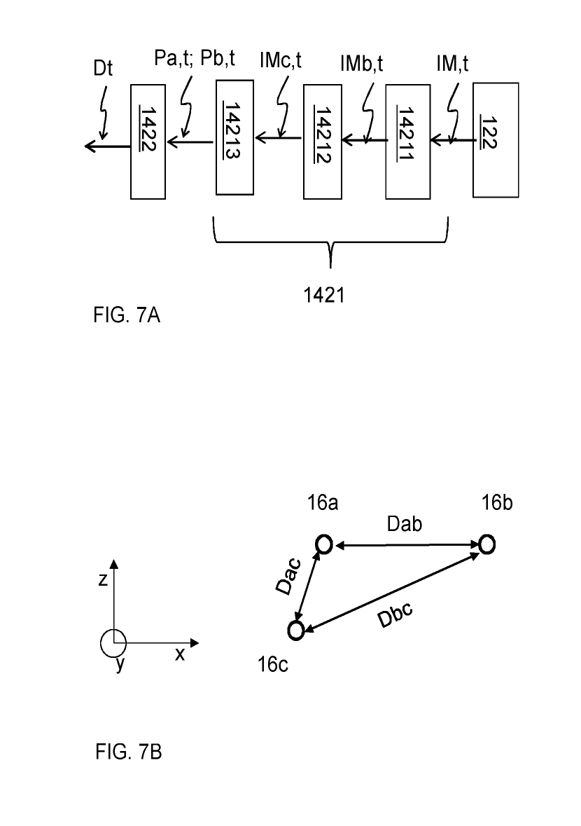

In an embodiment the at least one beacon 16 radiates non-visible radiation and the camera 122 is substantially insensitive to radiation other than the non-visible radiation radiated by the at least one beacon 16. In this way no substantial image processing is necessary to identify the position of the beacon or beacons in the images IM,t. The image data IM,t may for example in a practical embodiment the beacon 16 or set of beacons 16a, 16b, (16c) radiate infra-red radiation. FIG. 7A shows an example of part of a portable pointing device suitable for use in this embodiment. Therein pattern recognition module 1421 includes a first image processing part 14211 to convert the image IM, t into a binary image IMb,t, for example by applying a threshold function. Patter recognition module 1421 includes a second image processing part 14212 that reduces the binary image IMb,t, to an image IMc,t, wherein every cluster of foreground pixels is replaced by its center point. Pattern recognition module 1421 includes a third part 14213 that determines the positions Pa, t; Pb, t of those center points in the image IMc,t,. Instead of first converting the image IM, t into a binary image IMb,t, it is possible to directly identify center points of bright regions in the original image IM,t.

[Delta] position determining module 1422 then determines the changes of those positions Pa, t; Pb, tin subsequent images. Alternatively, delta position determining module 1422 determines the change in position pointed to by the user, wherein the respective pointing positions are estimated from the positions Pa, t; Pb, t of the predetermined pattern detected in subsequent captured images. As long a the roll angle does not change substantially, the relative position determining module 1422 can easily determine which position identified in an image IMc,t corresponds to which position identified in a preceding image IMc, t−1. For example a leftmost point may always be identified as originating from a first beacon, a rightmost point may always be identified as originating from a second beacon, and an uppermost point may always be identified as originating from a third beacon. Being able to identify the beacons makes it possible to identify and correct for changes in distance and roll angle. Therewith sufficient information is available to determine the motion trajectory performed by the user in pointing position coordinates. If it is not possible to identify the beacons used in this way, because more substantial roll movements of the portable pointing device occur, the following alternative solutions are possible to identify the beacons.

According to a first solution an accelerometer is provided to determine the roll angle. Based on the therewith observed roll angle a compensation is applied to the data directly or indirectly obtained from the captured image data. For example a rotation operation compensating for the observed roll angle is applied to the captured image data, to obtain a roll angle compensated image which is further processed as if it were the captured image itself. Alternatively the position(s) found for the one or more beacons in the originally captured image may be corrected to compensate for the roll angle. Still alternatively a roll angle compensation may be applied in any further processing stage.

According to a second solution the images are sampled at a relatively high repetition rate, so that the points resulting from the same beacon in subsequent images IMc,t−1, IMc,t always are closer to each other than a point from that same beacon in image IMc,t to a point resulting from another beacon in the previous image IMc,t−1. In this way the path of points from a beacon can be tracked in the sequence of images IMc,t. For this purpose a tracking engine, for example including a Kalman filter or a particle filter may be applied. According to the second solution the beacons 16a, 16b, 16c are arranged at mutually different distances Dab, Dbc and Dac, as shown in FIG. 7B. In this way the proper association between the positions Pa,t; Pb,t and Pc,t and the beacons 16a, 16b, 16c can always be made on the basis of the pattern in which they are arranged. Of course this is also applicable when using a number of beacons larger than 3. A larger number of beacons, may be advantageous to correct for errors.

FIG. 8 schematically shows part of a user interaction system according to a further embodiment. Therein the at least one beacon 16 comprises a driving unit 162 to drive a photon radiation element 161 of the beacon according to a time-modulated pattern. The digital signal processor 14 includes a detector 143 for detecting image data IMD,t modulated according to that pattern. By way of example the driving unit 162 drives the photon radiation element 161 according to a block modulation with a modulation period T. The detector 143 for detecting image data IMD,t modulated according to that pattern may sample the image data IM,t retrieved with the camera 122 at any sample frequency provided that it is sufficiently high to detect the modulation. In practice good results were obtained with a beacon having a modulation of its intensity of about 10% of the DC value of its intensity. In case the detection is synchronized with the modulation it may be possible for example to determine the detected image data IMD,t as the absolute difference between subsequent samples of image data IM,t.

I.e. IMD(x,y,t)=ABS(IM(x,y,t)−IM(x,y,t-T/2)),

wherein x,y are the image coordinates.

The modulation method used for the beacon needs to have some different properties compared to possible interfering sources]. For example the modulation period is preferably selected relatively short in comparison to a period of intensity variations that may be caused by other photon radiation sources, e.g. monitors, TV-screens and light sources Alternatively more complex modulation patterns may be provided by driving unit 162 and detected by detector 143, which need not necessarily be at a high frequency.

In an embodiment as shown in FIG. 8 it is not necessary that the camera 122 is insensitive to radiation other than that emitted by the photon radiation element 161. Neither is it necessary that the radiation radiated by the photon radiation element 161 is of a non-visible type. The latter is however preferred for convenience of the user of the user interaction system.

In a variation of the embodiment as partly shown in FIG. 8 the photon radiation element 161 of the beacon 16 is capable of radiating photon radiation at mutually different wavelengths. In operation the driving unit 162 modulates the wavelength of the photon radiation element 161 according to a time-modulated pattern. The digital signal processor 14 includes a detector 143 for detecting image data IMD,t modulated according to that pattern. The driving unit 162 may for example cause the photon radiation element 161 to alternatively emit photon radiation in a first infrared wavelength band and in a second infrared wavelength band. [This describes the identification system that is not relevant for the invention] The camera 122 may have first sensor elements sensitive for the first wavelength band and second sensor elements sensitive for the second wavelength band. The detector 143 can then derive the detected image data IMD,t as the absolute difference between image obtained with the first sensor elements and the image obtained with the second sensor elements.

In again another embodiment, as shown in FIG. 9, a set of beacons 16a, . . . 16n is provided that emit photon radiation according to a particular spatial pattern. The digital signal processor 14 is provided with a pattern recognition module 145 that identifies the particular spatial pattern as the predetermined pattern within image data resulting from other sources. In response to the image data IM,t the pattern recognition module 145 provides pattern data IMP,t representing a position of the pattern, e.g. its center of mass (Px,y), and its orientation (Proll). A roll compensation module 147 subsequently uses the orientation data Proll to determine the motion trajectory MS from the detected center of mass Px,y.

Alternatively a single beacon may be provided that emits photon radiation according to a unique spatial pattern to be detected. In this case the camera 122 may need a higher resolution than in case multiple beacons 16a, . . . , 16n are used that are distributed in space as in this case the dimensions of the spatial pattern that results in the captured image typically are smaller than the dimensions of a spatial pattern that result from a plurality of beacons distributed in space. Also one or more of the beacons as shown in FIG. 9 may individually emit photon-radiation according to a particular spatial pattern.

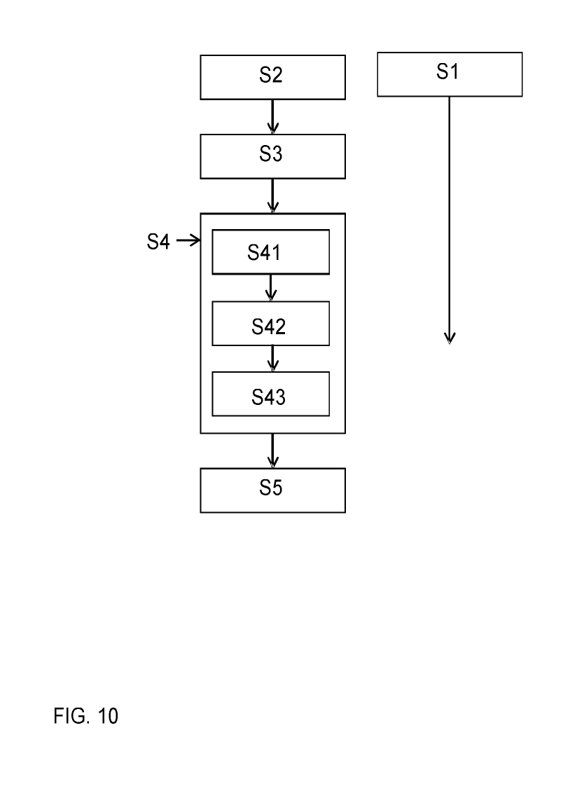

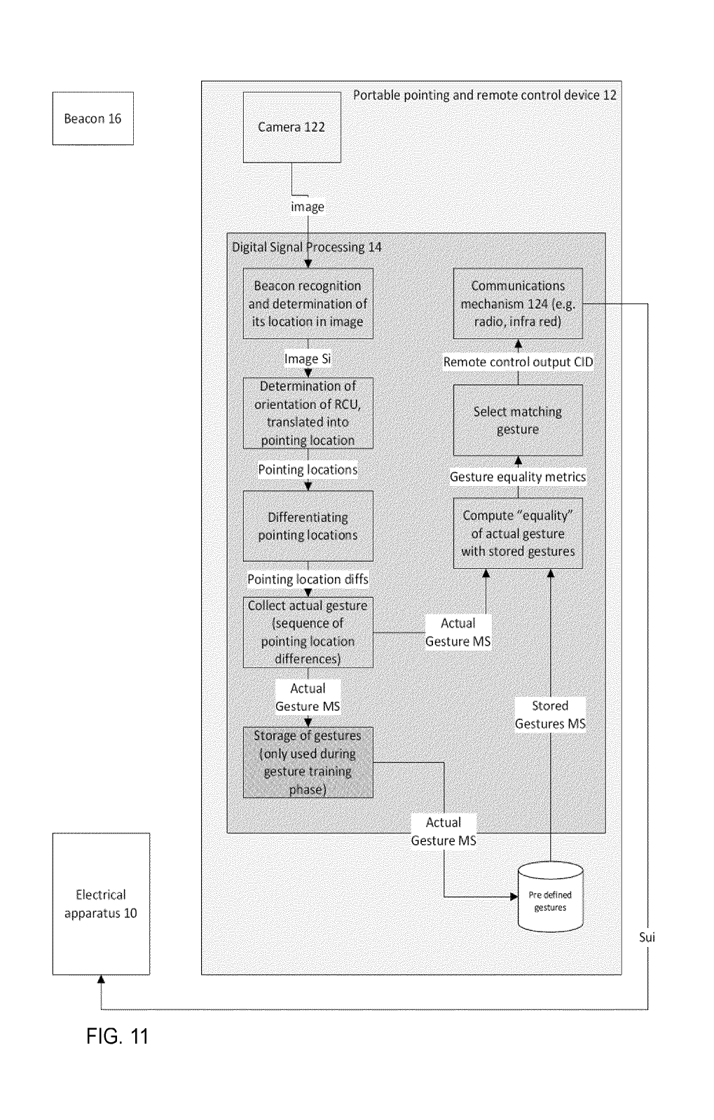

FIG. 10 schematically shows a user interaction method in a system as specified above with reference to the previous drawings and comprising an electrical apparatus 10, a portable pointing device 12 with a camera 122, a digital signal processor 14 and at least one beacon 16 not being part of the portable pointing device. For additional explanation reference is further made to FIG. 11, showing a preferred embodiment of a system wherein the method is applied. The method shown in FIG. 10 comprises the following steps.

As a first step 51, a user makes a gesture with the portable pointing device 12. To that end the user may direct the portable pointing device 12 to an electrical apparatus to be controlled and move the point targeted at along an imaginary curve.

As a second step S2, while making the gesture, successive images are captured with the camera 122 comprised in the portable pointing device. In a third step S3, successive image data IM,t representing the successive images is received by a digital processor 14, which may be integrated in the pointing device 12 or may be provided elsewhere.

The successive image data IM,t is subsequently processed in a fourth step S4 by the digital processor. This processing may include the following processing steps. In a first processing step S41 successive positions Pa,t of a predetermined pattern are determined in the successive images. Typically the predetermined pattern results from a beacon or a plurality of beacons that are deliberately arranged in a space 20 where the portable pointing device 12 is used. As can be seen in FIG. 11, in this case the first processing step S41 involves “Beacon recognition and determination of its location in the image”.

A second processing step S42 involves identifying a gesture on the basis of difference data resulting from differences of said position in said successive images. A particular implementation of this second processing step S42 is further shown in more detail in FIG. 11. As shown therein the successive positions Pa,t of the predetermined pattern determined in the successive images is used to determine an orientation of the remote control unit RCU, which on its turn can be associated with a position pointed at by the user with the RCU. It is noted that this pointing position may be displayed on a display screen as a kind of feedback to the user. Subsequently, the difference is determined between the pointing positions that were obtained in mutually successive images. Therewith a sequence of differences (Actual gesture MS) is obtained that corresponds to the gesture that was made by the user. This is denoted in FIG. 11 as collect actual gesture (sequence of pointing location differences). The sequence so obtained is compared with a plurality sequences stored for pre-defined gestures. A gesture equality metric is used to determine which pre-defined gesture best corresponds to the gesture made by the user. A time-warping method may be used to allow for some tolerance in the speed with which the user makes the gesture. It is determined which command is associated with the best matching gesture, and the identification CID of this command is provided in step S43 to transmission unit 124 for transmission by signal Sui to the electrical apparatus 10 in step S5 as soon as the gesture is identified in step S42. It is noted that transmission of a CID may be inhibited if the determined equality for the best-matching predefined is less than a predetermined threshold value. In that way the risk can be reduced that a command is executed that does not correspond to the intention of the user.

The embodiment as illustrated in FIG. 11 also has a training mode to allow the user to add additional gestures to the set of pre-defined gestures. To that end the user can make the gesture that should be added to this set. In the same manner as described above, the sequence of pointing location differences is obtained from the camera images. Upon completion of the gesture, the sequence of pointing location differences as well as its associated CID is added to the set of pre defined gestures. The user may enter the CID to be associated with the gesture at any time in the training mode. In an embodiment the user is requested to make the gesture a few times therewith making it possible to estimate a standard deviation in the sequence of pointing location differences for the sequence to be added.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

1. User interaction system, comprising:
an electrical apparatus;
a portable pointing device operable by a user for making a gesture, which portable pointing device includes a camera connected thereto for obtaining successive images from said space; and
a digital signal processor capable of receiving and processing the successive images to identify a gesture made with said pointing device, and capable of transmitting user interface information to the electrical apparatus, said user interface information representing control information for said electrical apparatus corresponding to the identified gesture, where said digital signal processor comprises a pattern recognition module for recognizing a predetermined pattern in said successive images
characterized in that the digital signal processor is further arranged, while receiving successive images data representing said successive images captured by the camera, to process the successive image data until a gesture, based on differences of successive positions of recognized predetermined patterns in successive images obtained by the camera can only be attributed to a single gesture,
the digital signal processor further being arranged to output command identification data, which represents a user interaction command, corresponding with the identified gesture,
the digital signal processor being further arranged to transmit the user interface information to the electrical apparatus as soon as the gesture is identified, which user interface information is constructed from said command identification data.

2. User interaction system according to claim 1, wherein said digital signal processor further includes a spatial transformation unit for applying a spatial transformation to said estimated position in order to obtain an estimated pointing position.

3. User interaction system according to claim 2, wherein said electrical apparatus includes a display screen, and is arranged to display said estimated pointing position on said display screen.

4. User interaction system according to claim 1, further comprising at least one beacon that radiates photon radiation, the at least one beacon being arranged in said space and not being part of the portable pointing device, the predetermined pattern to be recognized being a pattern resulting from said at least one beacon.

5. User interaction system according to claim 4, wherein the at least one beacon is arranged to radiate non-visible radiation and wherein the camera is substantially insensitive to radiation other than the non-visible radiation radiated by the at least one beacon.

6. User interaction system according to claim 4, wherein the at least one beacon comprises a driving unit arranged to drive a photon radiation element of said beacon according to a time-modulated pattern and wherein the digital signal processor includes a detector arranged to detect image data modulated according to that pattern.

7. User interaction method in a system comprising an electrical apparatus, a portable pointing device with a camera, and a digital signal processor said method comprising controlling said electrical apparatus by identifying gestures made with said portable pointing device, said method comprising the steps of
while making a gesture with said portable pointing device:
capturing successive images with said camera comprised in the portable pointing device; and
receiving successive image data representing said successive images by said digital signal processor,
processing the successive image data by said digital processor, until a gesture can only be attributed to a single gesture, said processing including
determining successive positions of a predetermined pattern in successive images obtained by the camera,
identifying a gesture on the basis of difference data resulting from differences of said successive positions in said successive images,
outputting command identification data, which represents a user interaction command, corresponding with the identified gesture,
transmitting user interface information to the electrical apparatus, which user interface information is constructed from said command identification data.

8. User interaction method according to claim 7, wherein said processing further includes applying a spatial transformation to said estimated position in order to obtain an estimated pointing position.

9. User interaction method according to claim 8, further comprising displaying said estimated pointing position on a display screen.

10. User interaction method according to claim 7, further comprising radiating photon radiation with at least one beacon, the predetermined pattern to be recognized being a pattern resulting from said photon radiation.

11. A portable pointing device for use in a system as claimed in claim 1, operable by a user for pointing to a region in space, which portable pointing device includes
a camera connected thereto for obtaining images from said space; and
a digital signal processor, capable of receiving and processing the subsequent images to identify a gesture made with said pointing device, and capable of transmitting user interface information to the electrical apparatus, said user interface information representing control information for said electrical apparatus corresponding to the identified gesture, characterized in that said digital signal processor comprises a pattern recognition module for recognizing a predetermined pattern in said subsequent images and for estimating a position of said pattern in said subsequent images, and a gesture matching unit arranged for to process difference data resulting from differences of said position in said subsequent images until a gesture can only be attributed to a single gesture.

12. A storage medium having stored thereon a computer program enabling a digital signal processor to carry out the method of claim 7.
